(19) United States
(12) Patent Application Publication
(10) Pub. No.: US 2026/0279860 A1
(43) Pub. Date: Sep. 17, 2026

(54) FUEL CELL APPARATUS

(71) Applicants: Hyundai Motor Company, Seoul (KR); Kia Corporation, Seoul (KR)

(72) Inventor: Ju Hyeop Lee, Hwaseong-si (KR)

(21) Appl. No.: 19/243,237

(22) Filed: Jun. 19, 2025

(30) Foreign Application Priority Data
Mar. 12, 2025 (KR) 10-2025-0032147

(51) Int. Cl. H01M 8/04746; H01M 8/04119; H01M 8/04223

(52) U.S. Cl. CPC H01M 8/04776; H01M 8/04126; H01M 8/04156; H01M 8/04231

(57) ABSTRACT

Disclosed is a fuel cell apparatus. The fuel cell apparatus includes a fuel cell including a cell stack including a plurality of unit cells stacked, an air compressor configured to compress air, an air cooler configured to cool air discharged from the air compressor and to discharge the cooled air, a humidifier configured to humidify air discharged from the air cooler and to supply the humidified air to the cell stack, a gas-liquid separator configured to separate gas and liquid from air having passed through the humidifier after being discharged from the cell stack, and a pipe configured to discharge air compressed by the air compressor after being separated in the gas-liquid separator to the outside.

### CROSS-REFERENCE TO RELATED APPLICATIONS

This application claims the benefit of Korean Patent Application No. 10-2025-0032147, filed on Mar 12, 2025, which is hereby incorporated by reference as if fully set forth herein.

### TECHNICAL FIELD

Embodiments relate to a fuel cell apparatus.

### BACKGROUND

A cell constituting a fuel cell included in a fuel cell apparatus includes a polymer electrolyte membrane. Air is supplied to one side (a cathode) of the electrolyte membrane, and hydrogen is supplied to the other side (a fuel electrode or an anode) of the electrolyte membrane, thereby generating electricity. The generated electricity may be used to operate the fuel cell apparatus. The fuel cell apparatus may include a hydrogen processing unit, an air processing unit, and a cooling medium processing unit.

The hydrogen processing unit manages inflow and outflow of hydrogen to and from the fuel cell. That is, the hydrogen processing unit serves to introduce hydrogen from the outside into the fuel cell and to discharge a reaction gas, which is hydrogen, and condensate flowing out of the fuel cell to the outside.

The cooling medium processing unit manages inflow and outflow of a cooling medium to and from the fuel cell. That is, the cooling medium processing unit serves to introduce the cooling medium into the fuel cell and to discharge the cooling medium flowing out of the fuel cell to the outside.

The air processing unit manages inflow and outflow of air containing oxygen between the outside and the fuel cell. That is, the air processing unit serves to introduce air containing oxygen from the outside into the fuel cell and to discharge a reaction gas, which is oxygen, and condensate flowing out of the fuel cell to the outside. The air processing unit uses an air compressor to compress the air introduced from the outside. However, because the air compressor consumes a large amount of power, it reduces the overall output of the fuel cell apparatus. Therefore, research with the goal of addressing this issue is underway.

### SUMMARY

Accordingly, embodiments are directed to a fuel cell apparatus that substantially obviates one or more problems due to limitations and disadvantages of the related art.

Embodiments provide a fuel cell apparatus capable of reducing power consumption.

However, the aspects of the disclosure are not limited to the above-mentioned aspects, and other aspects not mentioned herein will be clearly understood by those skilled in the art from the following description.

Additional advantages, aspects, and features of the disclosure will be set forth in part in the description which follows and in part will become apparent to those having ordinary skill in the art upon examination of the following or may be learned from practice of the disclosure. The aspects and other advantages of the disclosure may be realized and attained by the structure particularly pointed out in the written description and claims hereof as well as the appended drawings.

A fuel cell apparatus according to an embodiment may include a fuel cell including a cell stack including a plurality of unit cells stacked, an air compressor configured to compress air, an air cooler configured to cool air discharged from the air compressor and to discharge the cooled air, a humidifier configured to humidify air discharged from the air cooler and to supply the humidified air to the cell stack, a gas-liquid separator configured to separate gas and liquid from air having passed through the humidifier after being discharged from the cell stack, and a pipe configured to discharge air compressed by the air compressor after being separated in the gas-liquid separator to the outside.

In an example, the air compressor may be implemented as an expander type.

In an example, the pipe may be configured to discharge the air discharged from the air compressor in a first direction, which is a traveling direction of the fuel cell apparatus.

In an example, the fuel cell apparatus may further include a system frame on which at least one of the cell stack, the air compressor, the humidifier, or the gas-liquid separator is disposed.

In an example, the cell stack may be disposed on the system frame, and the air compressor, the humidifier, and the gas-liquid separator may be disposed under the system frame.

In an example, the system frame may include a first system frame disposed at a front side of the fuel cell apparatus and a second system frame disposed at a rear side of the fuel cell apparatus, and the cell stack may include a first cell stack disposed on the first system frame and a second cell stack disposed on the second system frame.

In an example, the air compressor may include a first air compressor disposed under the first system frame and a second air compressor disposed under the second system frame, the humidifier may include a first humidifier disposed under the first system frame and a second humidifier disposed under the second system frame, and the gas-liquid separator may include a first gas-liquid separator disposed under the first system frame and a second gas-liquid separator disposed under the second system frame.

In an example, the fuel cell apparatus may further include first and second side members extending in a first direction, which is a traveling direction of the fuel cell apparatus, and disposed opposite each other in a second direction intersecting the first direction.

In an example, the system frame may be at least partially mounted to the first and second side members.

In an example, the first system frame may have a top surface positioned higher than the top surface of each of the first and second side members, and the second system frame may have a bottom surface positioned lower than the bottom surface of each of the first and second side members.

In an example, the gas-liquid separator may have a top surface positioned lower than the top surface of each of the first and second side members.

In an example, the pipe may include a first portion extending in a second direction intersecting a first direction, which is a traveling direction of the fuel cell apparatus, and defining a flow path for flow of air discharged from the air compressor and a second portion bent and extending from the first portion in the first direction and defining a flow path for flow of air discharged from the first portion.

In an example, the first direction in which the second portion extends may be a direction toward the rear side of the fuel cell apparatus.

In an example, the fuel cell apparatus may further include a hydrogen purge valve connected to a distal end portion of the pipe and configured to discharge unreacted hydrogen flowing out of the cell stack.

In an example, the fuel cell apparatus may further include an air pressure controller disposed between the gas-liquid separator and the air compressor and configured to control the pressure of the air separated in the gas-liquid separator.

In an example, the air pressure controller may be integrated with a rear end of the gas-liquid separator.

In an example, the fuel cell apparatus may further include an air pressure controller disposed between the air compressor and the pipe and configured to control the pressure of air discharged from the air compressor to the pipe.

In an example, the fuel cell apparatus may further include an air pressure controller disposed between the humidifier and the gas-liquid separator and configured to control the pressure of air discharged from the humidifier.

In an example, the air pressure controller may be integrated with the humidifier.

In an example, the air pressure controller may be integrated with the gas-liquid separator.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell apparatus according to an embodiment;

FIG. 2 is a view showing the configuration of an embodiment of the air compressor shown in FIG. 1;

FIGS. 3A and 3B are partial plan views of the fuel cell apparatus shown in FIG. 1;

FIG. 4 is a partial rear view of the fuel cell apparatus shown in FIG. 1;

FIG. 5 is a side cross-sectional view of the fuel cell apparatus according to the embodiment;

FIGS. 6A to 6D are views showing various embodiments of the fuel cell apparatus shown in FIG. 1;

FIG. 7 is a plan view of a fuel cell vehicle according to a first comparative example;

FIG. 8 is a side view of a fuel cell vehicle according to a second comparative example; and

FIG. 9 is a block diagram of a fuel cell apparatus according to a third comparative example.

### DETAILED DESCRIPTION OF ILLUSTRATIVE EMBODIMENTS

The present disclosure will now be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a fuel cell apparatus 100 according to an embodiment will be described below with reference to the accompanying drawings. The fuel cell apparatus 100 will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the embodiments are not limited thereto. That is, the x-axis, the y-axis, and the z-axis may intersect each other obliquely.

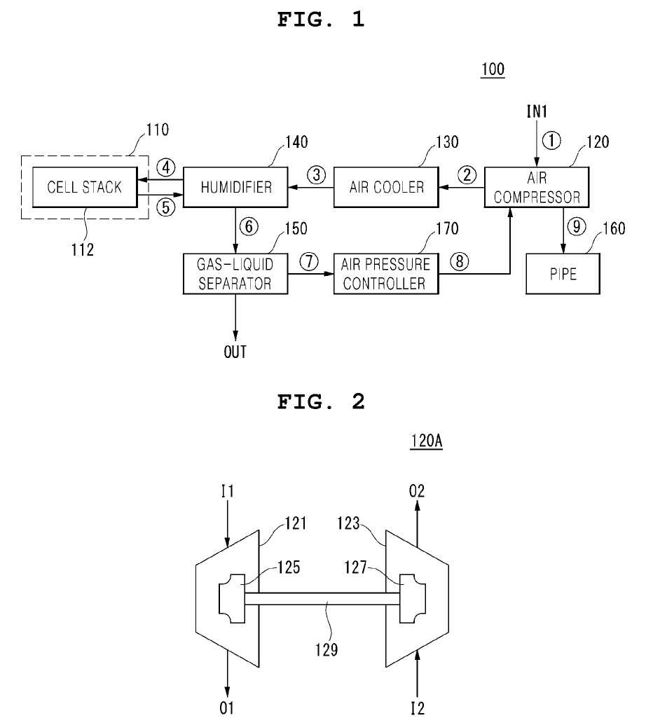

FIG. 1 is a block diagram of the fuel cell apparatus 100 according to the embodiment.

The fuel cell apparatus 100 according to the embodiment may include a fuel cell 110, an air compressor 120, an air cooler 130, a humidifier 140, a gas-liquid separator 150, and a pipe 160.

In FIG. 1, components other than the fuel cell 110 may be included in an air processing unit. The air processing unit manages inflow and outflow of air containing oxygen between the outside and the fuel cell 110. That is, the air processing unit serves to introduce air containing oxygen from the outside into the fuel cell 110 and to discharge a reaction gas, which is oxygen, and condensate flowing out of the fuel cell 110 to the outside.

The fuel cell 110 is a device that converts chemical energy of oxygen and hydrogen into electrical energy through an electrochemical reaction. The fuel cell 110 may include a plurality of unit fuel cells stacked in at least one of a vertical direction or a horizontal direction. The unit fuel cell may be a polymer electrolyte membrane fuel cell (or a proton exchange membrane fuel cell) (PEMFC), which has been studied most extensively as a power source for driving the fuel cell apparatus 100, for example, fuel cell vehicles. However, the embodiments are not limited to any specific form, configuration, or appearance of the unit fuel cell.

The unit fuel cell included in the fuel cell 110 may include end plates (pressing plates or compression plates) (not shown) and a cell stack 112.

The cell stack 112 may include a plurality of unit cells stacked in the horizontal direction. Tens to hundreds of unit cells, for example, 100 to 400 unit cells, may be stacked to form the cell stack. The number of unit fuel cells included in the fuel cell 110 and the number of unit cells included in the cell stack of the unit fuel cell may be determined depending on the intensity of power to be supplied from the fuel cell 110 to a load (not shown).

The end plates may be disposed at respective ends of the cell stack 112 and may support and fix the plurality of unit cells. That is, one of the end plates may be disposed at one of the two opposite ends of the cell stack, and the other of the end plates may be disposed at the other of the two opposite ends of the cell stack.

In addition, the fuel cell 110 may further include a clamping member (not shown), which has a bar shape, a long bolt shape, a belt shape, or a rigid rope shape to clamp the plurality of unit cells. For example, in each unit fuel cell, the clamping member serves to clamp the plurality of unit cells in the horizontal direction together with the end plates.

The embodiments are not limited to any specific form of the fuel cell 110.

The air compressor 120 may compress atmospheric-pressure air ① introduced from the outside through a blower IN1, and may supply the compressed air ② to the air cooler 130. Although not shown, an air purification unit (not shown) may additionally be disposed in order to supply clean air to the fuel cell 110. The air purification unit serves to purify the air received from the outside.

The air purification unit may be disposed on an upstream or downstream side of the air compressor 120. The air purification unit may be disposed as a separate component in the form of a filter. The air purification unit may be disposed on a line communicating with at least one of the air compressor 120 or the air cooler 130 or may be directly disposed at an end of the air compressor 120 or the air cooler 130.

If the air purification unit is disposed on the upstream side of the air compressor 120, the air compressor 120 compresses air purified by the air purification unit, and outputs the compressed air to the air cooler 130.

The air cooler 130 may cool the compressed air ② discharged from the air compressor 120, and may discharge the cooled air ③ to the humidifier 140.

The humidifier 140 may humidify the cooled air discharged from the air cooler 130, and may supply the humidified air ④ to the cell stack 112.

Alternatively, the humidifier 140 may dehumidify air ⑤ containing moisture discharged from the cell stack 112, and may supply the dehumidified air to the gas-liquid separator 150.

The gas-liquid separator 150 may separate gas and liquid from the air ⑥ dehumidified by the humidifier 140 after being discharged from the cell stack 112. Then, the gas-liquid separator 150 may discharge the separated gas ⑦ to the air compressor 120 and may discharge the separated liquid through an outlet OUT. In this manner, the gas-liquid separator 150 serves to remove droplets from the dehumidified air ⑥.

Because the size and weight of the gas-liquid separator 150 significantly affect components surrounding the gas-liquid separator 150, the placement of the gas-liquid separator 150 may be determined based thereon.

The pipe 160 may discharge the air ⑨ compressed by the air compressor 120 after being separated in the gas-liquid separator 150 to the outside.

The fuel cell apparatus 100 according to the embodiment may further include an air pressure controller (APC) (or a pressure control valve) 170. The air pressure controller 170 may be disposed between the gas-liquid separator 150 and the air compressor 120, may control the pressure of air separated in the gas-liquid separator 150, and may discharge the pressure-controlled air ⑧ to the air compressor 120.

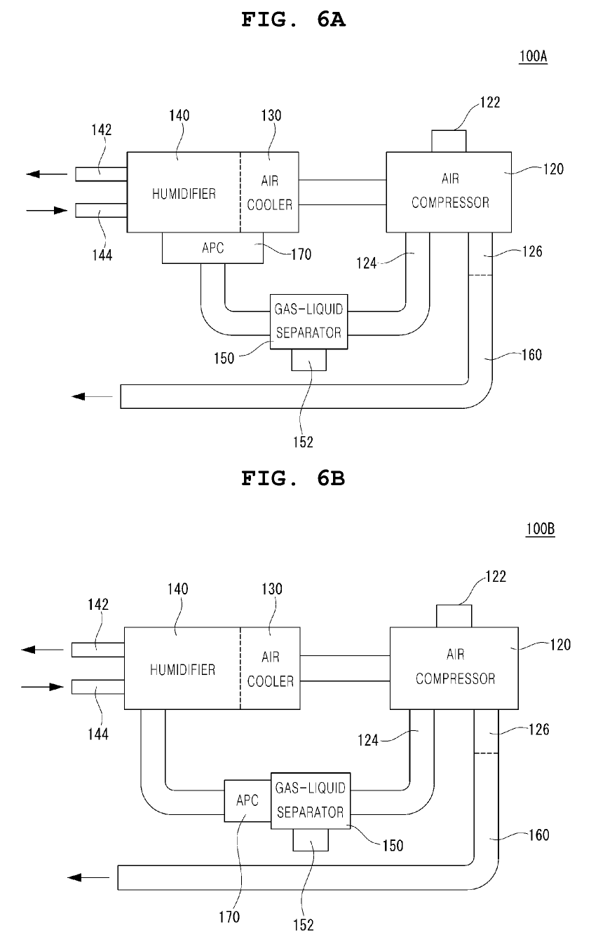

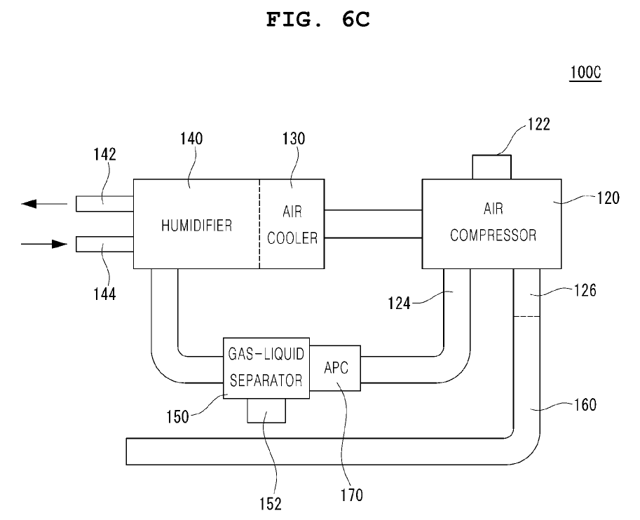

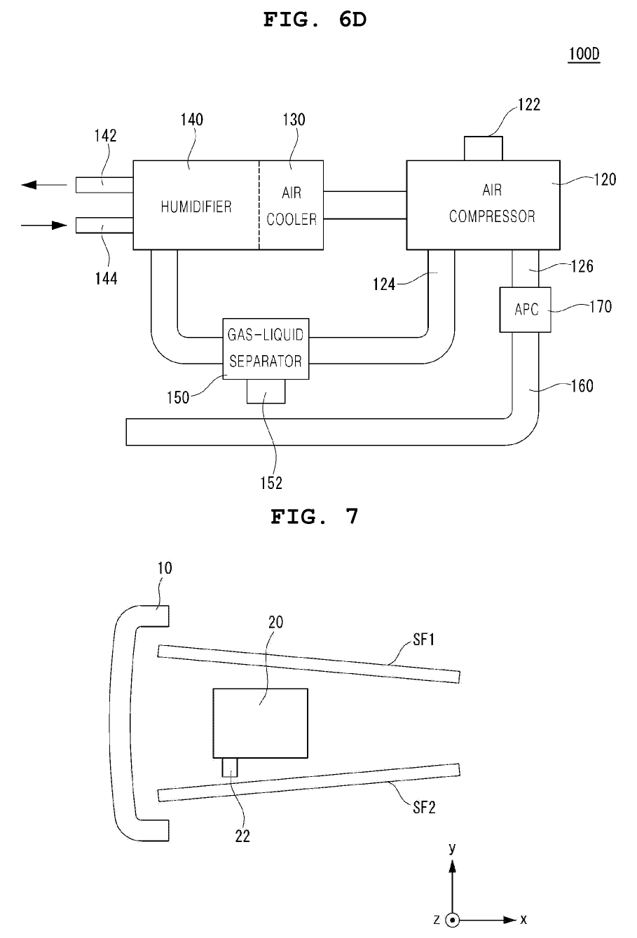

Hereinafter, the fuel cell apparatus 100 will be described based on a configuration in which the air pressure controller 170 is disposed between the gas-liquid separator 150 and the air compressor 120. However, the following description may also apply to configurations in which the air pressure controller 170 is disposed at a position different from that shown in FIG. 1, as will be described later with reference to FIGS. 6A to 6D.

The air compressor 120 recompresses the air discharged from the air pressure controller 170, and discharges the recompressed air ⑨ to the outside through the pipe 160.

According to the embodiment, the air compressor 120 may be implemented as an expander-type compressor that compresses air introduced from the outside and supplies the compressed air to the humidifier 140 via the air cooler 130, while also compressing air introduced through the air pressure controller 170 and discharging the compressed air to the pipe 160.

FIG. 2 is a view showing the configuration of an embodiment 120A of the air compressor 120 shown in FIG. 1.

The expander-type air compressor 120A shown in FIG. 2 includes an expander (or a turbine) 121, a compressor 123, and a shaft 129. The expander 121 includes an expander wheel 125, and the compressor 123 includes a compressor wheel 127.

The compressor 123 compresses air I2 introduced from the outside, and discharges the compressed air O2. The expander 121 compresses air I1 discharged from the air pressure controller 170, and discharges the compressed air O1. The shaft 129 is shared between the expander 121 and the compressor 123.

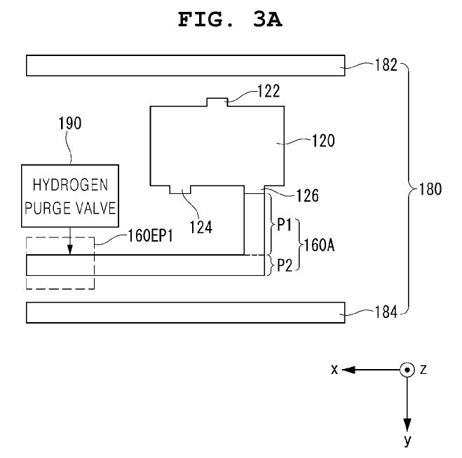

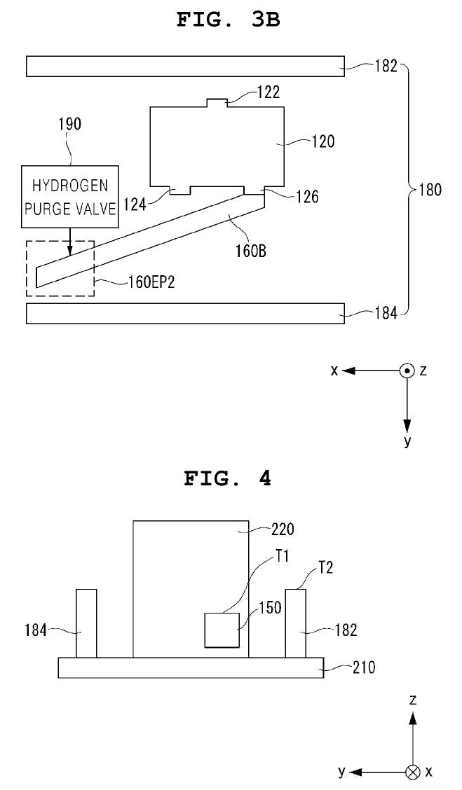

FIGS. 3A and 3B are partial plan views of an embodiment of the fuel cell apparatus 100 shown in FIG. 1.

The fuel cell apparatus 100 shown in FIGS. 3A and 3B may include a side member (a side structure or a vehicle body frame) 180, an air compressor 120, a pipe 160, and a hydrogen purge valve 190. Illustration of the fuel cell 110, the air cooler 130, the humidifier 140, the gas-liquid separator 150, and the air pressure controller 170 shown in FIG. 1 is omitted in FIGS. 3A and 3B. The air compressor 120 and the pipe 160 shown in FIGS. 3A and 3B correspond to embodiments of the air compressor 120 and the pipe 160 shown in FIG. 1, respectively.

The air compressor 120 may include a blower 122, a turbine front end 124, and a turbine rear end 126. The blower 122 corresponds to a first inlet through which air is introduced into the air compressor 120. The turbine front end 124 corresponds to a second inlet through which air discharged from the air pressure controller 170 is introduced into the air compressor 120. The turbine rear end 126 corresponds to an outlet through which air is discharged from the air compressor 120 to the pipe 160.

The side member 180 may include first and second side members 182 and 184 extending in a first direction (i.e., the x-axis direction), which is a traveling direction of the fuel cell apparatus 100, and disposed opposite each other in a second direction (i.e., the y-axis direction) intersecting the first direction. That is, the first and second side members 182 and 184 may correspond to vehicle body structures forming side portions of an engine compartment of the fuel cell apparatus 100. In addition, the fuel cell apparatus 100 may further include at least one cross member (not shown). The at least one cross member is a part disposed (or located) between the first side member 182 and the second side member 184, and may be integrally formed with at least one of the first side member 182 or the second side member 184. However, the fuel cell apparatus 100 according to the embodiment is not limited as to the presence or absence of the cross member, a specific position at which the cross member is disposed, or a layout configuration of the cross member.

The pipe 160A may discharge air discharged from the air compressor 120 in the first direction.

According to an embodiment, as shown in FIG. 3A, the pipe 160A may include first and second portions P1 and P2.

The first portion P1 extends in the second direction and defines a flow path through which air discharged from the air compressor 120 flows. The second portion P2 is bent and extends from the first portion P1 in the first direction and defines a flow path through which air discharged from the first portion P1 flows in the first direction.

According to the embodiment, the first direction in which the second portion P2 extends may be a direction toward a rear side of the fuel cell apparatus 100. For example, if the fuel cell apparatus 100 travels in the -x-axis direction, air may flow in the +x-axis direction, i.e., toward the rear side of the fuel cell apparatus 100 through the pipe 160A, and may be discharged to the outside.

According to another embodiment, as shown in FIG. 3B, the pipe 160B may be formed to extend in an oblique direction without being bent so that air flows in the +x-axis direction, i.e., toward the rear side of the fuel cell apparatus 100, and is discharged to the outside.

The hydrogen purge valve 190 discharges unreacted hydrogen flowing out of the cell stack 112. To this end, the hydrogen purge valve 190 may be connected to a distal end portion of the pipe 160A or 160B, for example, a distal end portion 160EP1 of the second portion P2 shown in FIG. 3A or a distal end portion 160EP2 shown in FIG. 3B, to discharge unreacted hydrogen to the outside.

As shown in FIGS. 3A and 3B, the distal end portions 160EP1 and 160EP2 of the pipes 160A and 160B, through which air is finally discharged, may be located at the rearmost portion or the rear side of the fuel cell apparatus in a direction opposite the traveling direction of the fuel cell apparatus, that is, the fuel cell vehicle.

FIG. 4 is a partial rear view of the fuel cell apparatus 100 shown in FIG. 1.

The fuel cell apparatus 100 shown in FIG. 4 may include a side member 180 (182 and 184), a suspension 210, and a power module complete (PMC) 220.

The PMC 220 may be disposed between the first and second side members 182 and 184 on the suspension 210, and may include the components 110 to 170 shown in FIG. 1 and components of the balance of plant (BOP) that assist in the operation of the fuel cell 110.

According to the embodiment, a top surface T1 of the gas-liquid separator 150 may be positioned lower than a top surface T2 of each of the first and second side members 182 and 184.

In addition, the fuel cell apparatus according to the embodiment may further include a system frame.

At least a portion of the system frame is mounted to (supported by or connected to) at least one of the first side member 182 or the second side member 184, and serves to support at least one of the cell stack 112, the air compressor 120, the humidifier 140, or the gas-liquid separator 150.

The cell stack 112 may be disposed on the system frame, and the air compressor 120, the humidifier 140, and the gas-liquid separator 150 may be disposed in parallel in a horizontal direction under the system frame.

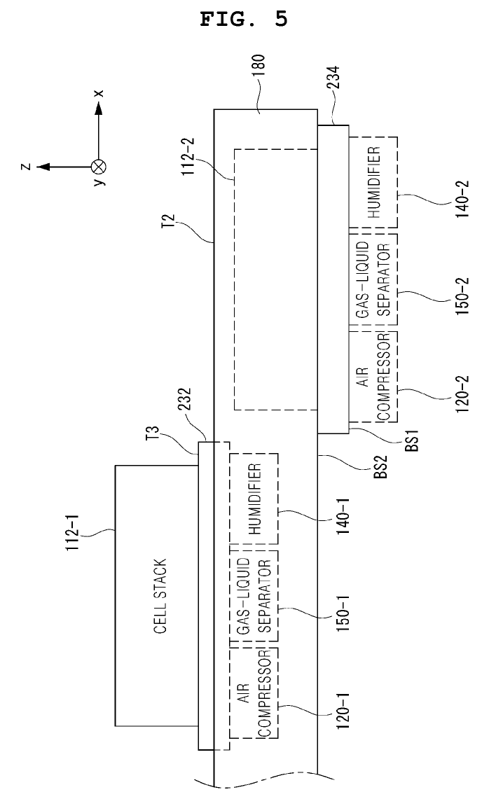

FIG. 5 is a side cross-sectional view of the fuel cell apparatus according to the embodiment.

According to an embodiment, as shown in FIG. 5, the system frame may include a first system frame 232 disposed at a front side of the fuel cell apparatus 100 and a second system frame 234 disposed at a rear side of the fuel cell apparatus 100.

For example, the cell stack 112 may include a first cell stack 112-1 disposed on the first system frame 232 and a second cell stack 112-2 disposed on the second system frame 234.

The air compressor 120 may include a first air compressor 120-1 disposed under the first system frame 232 and a second air compressor 120-2 disposed under the second system frame 234.

The humidifier 140 may include a first humidifier 140-1 disposed under the first system frame 232 and a second humidifier 140-2 disposed under the second system frame 234.

The gas-liquid separator 150 may include a first gas-liquid separator 150-1 disposed under the first system frame 232 and a second gas-liquid separator 150-2 disposed under the second system frame 234.

The first cell stack 112-1, the first air compressor 120-1, the first humidifier 140-1, and the first gas-liquid separator 150-1 perform the same functions as the cell stack 112, the air compressor 120, the humidifier 140, and the gas-liquid separator 150 described above, respectively, and thus redundant descriptions thereof will be omitted.

The second cell stack 112-2, the second air compressor 120-2, the second humidifier 140-2, and the second gas-liquid separator 150-2 perform the same functions as the cell stack 112, the air compressor 120, the humidifier 140, and the gas-liquid separator 150 described above, respectively, and thus redundant descriptions thereof will be omitted.

The configuration shown in FIG. 5 corresponds to a case in which the fuel cell apparatus 100 according to the embodiment is a commercial vehicle such as a truck or a bus.

According to another embodiment, if the fuel cell apparatus 100 is a passenger vehicle, the fuel cell apparatus 100 may include the first cell stack 112-1, the first air compressor 120-1, the first humidifier 140-1, the first gas-liquid separator 150-1, and the first system frame 232, or may alternatively include the second cell stack 112-2, the second air compressor 120-2, the second humidifier 140-2, the second gas-liquid separator 150-2, and the second system frame 234.

According to the embodiment, a top surface T3 of the first system frame 232 may be positioned higher than a top surface T2 of each of the first and second side members 180 (182 and 184), and a bottom surface BS1 of the second system frame 234 may be positioned lower than a bottom surface BS2 of each of the first and second side members 180 (182 and 184).

FIGS. 6A to 6D are views showing various embodiments 100A, 100B, 100C, and 100D of the fuel cell apparatus 100 shown in FIG. 1.

Each of the fuel cell apparatuses 100A to 100D shown in FIGS. 6A to 6D includes an air compressor 120, an air cooler 130, a humidifier 140, a gas-liquid separator 150, a pipe 160, and an air pressure controller (APC) 170.

Because the air compressor 120, the air cooler 130, the humidifier 140, the gas-liquid separator 150, the pipe 160, and the air pressure controller 170 shown in FIGS. 6A to 6D correspond to the air compressor 120, the air cooler 130, the humidifier 140, the gas-liquid separator 150, the pipe 160, and the air pressure controller 170 shown in FIG. 1, respectively, the same components are denoted by the same reference numerals, and redundant descriptions thereof will be omitted.

Illustration of the fuel cell 110 shown in FIG. 1 is omitted in FIGS. 6A to 6D.

For example, as shown in FIGS. 6A to 6D, the air cooler 130 and the humidifier 140 may be integrally implemented.

The humidifier 140 may include a second outlet 142 through which humidified air is discharged to the fuel cell 110 and a third inlet 144 through which air discharged from the fuel cell 110 is introduced into the humidifier 140.

The gas-liquid separator 150 may include a third outlet 152 through which separated liquid is discharged.

According to an embodiment, the APC 170 may be disposed between the humidifier 140 and the gas-liquid separator 150, and may control the pressure of air discharged from the humidifier 140. For example, as shown in FIG. 6A, the humidifier 140 and the APC 170 may be integrally implemented. Alternatively, as shown in FIG. 6B, the APC 170 and the gas-liquid separator 150 may be integrally implemented.

According to another embodiment, as shown in FIGS. 1 and 6C, the APC 170 may be disposed between the gas-liquid separator 150 and the turbine front end 124 of the air compressor 120, and may control the pressure of air separated in the gas-liquid separator 150. For example, as shown in FIG. 6C, the rear end of the gas-liquid separator 150 and the APC 170 may be integrally implemented.

According to still another embodiment, the APC 170 may be disposed between the turbine rear end 126 of the air compressor 120 and the pipe 160, and may control the pressure of air discharged from the air compressor 120 to the pipe 160. For example, the APC 170 may be implemented separately from the air compressor 120 and the pipe 160.

Hereinafter, the fuel cell apparatus according to the embodiment will be described in comparison with a comparative example with reference to the accompanying drawings.

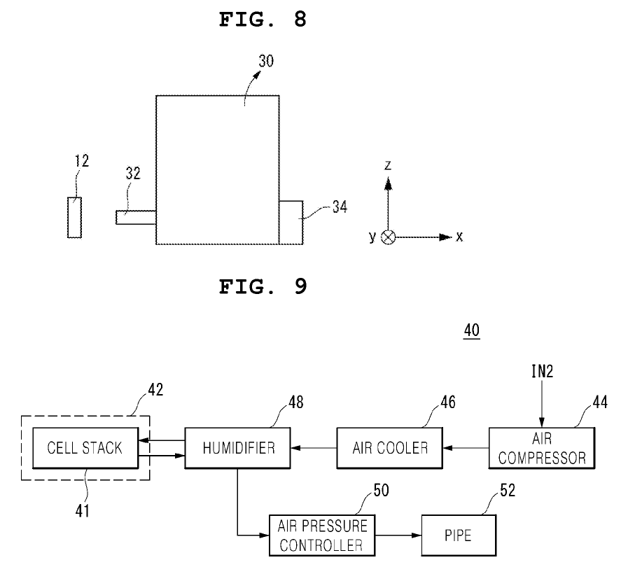

FIG. 7 is a plan view of a fuel cell vehicle according to a first comparative example, and FIG. 8 is a side view of a fuel cell vehicle according to a second comparative example.

The fuel cell vehicle according to the first comparative example shown in FIG. 7 includes a front bumper 10, first and second side members SF1 and SF2, a PMC 20, and an exhaust unit 22, and the fuel cell vehicle according to the second comparative example shown in FIG. 8 includes a front bumper 12, first and second side members SF1 and SF2, a PMC 30, and an exhaust unit 32. The first and second side members SF1 and SF2 perform the same functions as the above-described first and second side members 182 and 184, respectively, and thus redundant descriptions thereof will be omitted.

A high-power fuel cell having a capacity of approximately 200 kW may typically be mounted in a commercial vehicle, for example, a truck or a bus.

Referring to FIG. 7, if the exhaust unit 22 is disposed at the turbine rear end of the PMC 20 in a truck, it may be difficult to discharge exhaust properly due to the presence of the side frame SF2.

Referring to FIG. 8, if the exhaust unit 32 is disposed at the turbine rear end of the PMC 30 based on the mounting orientation of the PMC 30 in a bus, the exhaust unit 32 faces the front side of the vehicle and a muffler 34 is located at the rear side of the vehicle. Therefore, it may be highly unreasonable or even impossible to connect the exhaust unit 32 and the muffler 34 to each other.

In contrast, according to the embodiment, the pipe 160A includes the second portion P2, as shown in FIG. 3A, or the pipe 160B extends in an oblique direction, as shown in FIG. 3B. Accordingly, as shown in FIGS. 3A, 3B, and 4, despite the presence of the side members 182 and 184, exhaust may be smoothly discharged toward the rear of the vehicle without interference from the side members 182 and 184.

When comparing the individual component weights of the humidifier 140 and the gas-liquid separator 150, the humidifier 140 is approximately five to six times heavier than the gas-liquid separator 150. Therefore, as shown in FIG. 6A, if the APC 170 is integrated with the humidifier 140, the integrated component of the humidifier 140 and the APC 170 may become excessively heavy, which may deteriorate the weight balance among the lower components and increase the mounting load of the humidifier. In consideration of this, as shown in FIG. 6B, if the APC 170 is integrated with the gas-liquid separator 150 rather than the humidifier 140, the fuel cell vehicle shown in FIG. 6B is more advantageous in terms of weight.

If the APC 170 is disposed as shown in FIGS. 6A to 6C, the air processing unit of the fuel cell apparatus may be made more compact.

In addition, due to the characteristics of the gas-liquid separator 150, which separates droplets from gas through rotational flow, maximum efficiency is achieved when the inlet flow is laminar flow. If the inlet flow is turbulent flow, it may be difficult to uniformly generate rotational flow. Therefore, the embodiments 100A and 100B may exhibit relatively reduced efficiency of the gas-liquid separator 150 compared to the embodiments 100C and 100D. As a result, the durability of the compressor may be degraded due to the droplets delivered to the turbine.

The performance of the turbine improves as the expansion ratio increases, the flow rate increases, and the turbine inlet temperature increases. The APC 170 serves to generate a differential pressure to control the expansion ratio (inlet pressure/outlet pressure) of the turbine. Therefore, compared to the embodiment shown in FIG. 6D, in which the APC 170 is disposed at the turbine rear end, the embodiment shown in FIG. 6C, in which the APC 170 is disposed at the turbine front end, may exhibit a greater expansion ratio, which may lead to improved performance.

FIG. 9 is a block diagram of a fuel cell apparatus according to a third comparative example, which includes a fuel cell 42, an air compressor 44, an air cooler 46, a humidifier 48, an air pressure controller 50, and a pipe 52.

The fuel cell 42 includes a cell stack 41. The fuel cell 42, the cell stack 41, the air cooler 46, the humidifier 48, the air pressure controller 50, and the pipe 52 shown in FIG. 9 perform the same functions as the fuel cell 110, the cell stack 112, the air cooler 130, the humidifier 140, the air pressure controller 170, and the pipe 160 shown in FIG. 1, respectively, and thus redundant descriptions thereof will be omitted.

The air compressor 44 shown in FIG. 9 compresses air introduced through a blower IN2 and discharges the compressed air to the humidifier 48 via the air cooler 46. Because the air compressor 44 operates in a one-way manner and consumes a large amount of power, it may cause reduction in the overall output of the fuel cell apparatus.

In contrast, unlike the air compressor 44 shown in FIG. 9, the air compressor 120 of the fuel cell apparatus 100 according to the embodiment is an expander-type compressor that compresses air introduced through the blower IN1 and supplies the compressed air to the humidifier 140 via the air cooler 130, while also compressing air introduced through the air pressure controller 170 and discharging the compressed air to the pipe 160.

As shown in FIG. 2, the air compressor 120 according to the embodiment is implemented as an expander-type air compressor, in which the shaft 129 is shared between the expander 121 and the compressor 123 and the rotational force generated from the expander 121 is transferred to the compressor 123 through the shared shaft 129, thereby reducing power consumption.

Accordingly, the fuel cell apparatus using the air compressor 120 of the embodiment may reduce power consumption compared to the fuel cell apparatus of the comparative example using the air compressor 44 shown in FIG. 9.

In addition, because the hydrogen purge valve 190 is connected to the pipe 160, reverse flow between the air electrode and the hydrogen electrode may be prevented, thereby ensuring robustness. Furthermore, output stability during high-power operation may be improved, and accordingly, the stack voltage and compressor power consumption during hydrogen purging may be reduced.

The fuel cell apparatus 100 according to the embodiment described above may be applied to vehicles, aircraft, ships, stationary power generation systems, etc., but the disclosure is not limited thereto.

As is apparent from the above description, the fuel cell apparatus according to the embodiment may allow exhaust to be smoothly discharged toward the rear of the vehicle without interference from side members, may provide a compact air processing unit, and may reduce power consumption.

However, the effects achievable through the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell apparatus, comprising:
a fuel cell including a cell stack including a plurality of unit cells stacked;
an air compressor configured to compress air;
an air cooler configured to cool air discharged from the air compressor and to discharge the cooled air;
a humidifier configured to humidify air discharged from the air cooler and to supply the humidified air to the cell stack;
a gas-liquid separator configured to separate gas and liquid from air having passed through the humidifier after being discharged from the cell stack; and
a pipe configured to discharge air compressed by the air compressor after being separated in the gas-liquid separator to an outside.

2. The fuel cell apparatus according to claim 1, wherein the air compressor is implemented as an expander type.

3. The fuel cell apparatus according to claim 1, wherein the pipe is configured to discharge the air discharged from the air compressor in a first direction, the first direction being a traveling direction of the fuel cell apparatus.

4. The fuel cell apparatus according to claim 1, further comprising a system frame,
wherein at least one of the cell stack, the air compressor, the humidifier, or the gas-liquid separator is disposed on the system frame.

5. The fuel cell apparatus according to claim 4, wherein:
the cell stack is disposed on the system frame, and
the air compressor, the humidifier, and the gas-liquid separator are disposed under the system frame.

6. The fuel cell apparatus according to claim 4, wherein:
the system frame includes:
a first system frame disposed at a front side of the fuel cell apparatus; and
a second system frame disposed at a rear side of the fuel cell apparatus, and
the cell stack includes:
a first cell stack disposed on the first system frame; and
a second cell stack disposed on the second system frame.

7. The fuel cell apparatus according to claim 6, wherein:
the air compressor includes:
a first air compressor disposed under the first system frame; and
a second air compressor disposed under the second system frame,
the humidifier includes:
a first humidifier disposed under the first system frame; and
a second humidifier disposed under the second system frame, and
the gas-liquid separator includes:
a first gas-liquid separator disposed under the first system frame; and
a second gas-liquid separator disposed under the second system frame.

8. The fuel cell apparatus according to claim 6, further comprising first and second side members extending in a first direction and disposed opposite each other in a second direction intersecting the first direction, the first direction being a traveling direction of the fuel cell apparatus.

9. The fuel cell apparatus according to claim 8, wherein the system frame is at least partially mounted to the first and second side members.

10. The fuel cell apparatus according to claim 8, wherein:
the first system frame has a top surface positioned higher than a top surface of each of the first and second side members, and
the second system frame has a bottom surface positioned lower than a bottom surface of each of the first and second side members.

11. The fuel cell apparatus according to claim 8, wherein the gas-liquid separator has a top surface positioned lower than a top surface of each of the first and second side members.

12. The fuel cell apparatus according to claim 1, wherein the pipe includes:
a first portion extending in a second direction intersecting a first direction and defining a flow path for flow of air discharged from the air compressor, the first direction being a traveling direction of the fuel cell apparatus; and
a second portion bent and extending from the first portion in the first direction and defining a flow path for flow of air discharged from the first portion.

13. The fuel cell apparatus according to claim 12, wherein the first direction in which the second portion extends is a direction toward a rear side of the fuel cell apparatus.

14. The fuel cell apparatus according to claim 1, further comprising a hydrogen purge valve connected to a distal end portion of the pipe, the hydrogen purge valve being configured to discharge unreacted hydrogen flowing out of the cell stack.

15. The fuel cell apparatus according to claim 1, further comprising an air pressure controller disposed between the gas-liquid separator and the air compressor, the air pressure controller being configured to control pressure of the air separated in the gas-liquid separator.

16. The fuel cell apparatus according to claim 15, wherein the air pressure controller is integrated with a rear end of the gas-liquid separator.

17. The fuel cell apparatus according to claim 1, further comprising an air pressure controller disposed between the air compressor and the pipe, the air pressure controller being configured to control pressure of air discharged from the air compressor to the pipe.

18. The fuel cell apparatus according to claim 1, further comprising an air pressure controller disposed between the humidifier and the gas-liquid separator, the air pressure controller being configured to control pressure of air discharged from the humidifier.

19. The fuel cell apparatus according to claim 18, wherein the air pressure controller is integrated with the humidifier.

20. The fuel cell apparatus according to claim 18, wherein the air pressure controller is integrated with the gas-liquid separator.
